(19) United States
(12) Patent Application Publication
(10) Pub. No.: US 2009/0218865 A1
(43) Pub. Date: Sep. 3, 2009

(54) ROTATING VEHICLE SEAT

(75) Inventors: Osamu FUKUI, Naka-gun (JP); Tetsuya IGAKURA, Chigasaki-shi (JP); Yu NAGAO, Ayase-shi (JP); Hideyuki ASAI, Yokohama-shi (JP)

Correspondence Address: GLOBAL IP COUNSELORS, LLP, 1233 20TH STREET, NW, SUITE 700, WASHINGTON, DC, 20036-2680, US

(73) Assignee: AUTECH JAPAN, INC., Chigasaki-shi (JP)

(21) Appl. No.: 12/393,387

(22) Filed: Feb. 26, 2009

(30) Foreign Application Priority Data
Feb. 29, 2008 (JP) 2008-048988

(51) Int. Cl. B60N 2/02

(52) U.S. Cl. 297/313

(57) ABSTRACT

A rotating seat for a vehicle includes a seat surface tilt angle varying mechanism, a seat surface rotating mechanism and a single drive source. The seat surface tilt angle varying mechanism is configured and arranged to vary a tilt angle of a seat surface of a seat body. The seat surface rotating mechanism is configured and arranged to rotate the seat surface. The drive source is configured and arranged to drive the seat surface tilt angle varying mechanism and the seat surface rotating mechanism.

### CROSS-REFERENCE TO RELATED APPLICATIONS

This application claims priority to Japanese Patent Application No. 2008-048988, filed on Feb. 29, 2008. The entire disclosure of Japanese Patent Application No. 2008-048988 is hereby incorporated herein by reference.

### BACKGROUND OF THE INVENTION

1. Field of the Invention

The present invention relates to a rotating vehicle seat provided in a vehicle.

2. Background Information

Japanese Laid-Open Patent Application Publication No. 2004-34908 discloses a conventional rotating vehicle seat configured such that a seat main body can be rotated relative to a vehicle. This conventional rotating vehicle seat has a rotating mechanism configured to rotate a seat surface of the vehicle seat between a normal position in which the seat faces toward a front of the vehicle and an embarkation position in which the seat faces toward an embarkation opening. By rotating to the embarkation position, the rotating vehicle seat enables a passenger to embark or disembark more easily through the embarkation opening.

In view of the above, it will be apparent to those skilled in the art from this disclosure that there exists a need for an improved rotating vehicle seat. This invention addresses this need in the art as well as other needs, which will become apparent to those skilled in the art from this disclosure.

### SUMMARY OF THE INVENTION

It has been proposed to provide a rotating vehicle seat with a tilt mechanism configured to vary a tilt angle of the seat surface so as to make it easier for a passenger to enter and leave the seat surface. Such a proposed rotating vehicle seat has a simple structure and operates in coordination with a door, thereby enabling the ease of embarkation to be improved without requiring any special manual operation to be performed. However, in such a proposed rotating vehicle seat, separate drive motors are provided for the tilt mechanism serving to vary the tilt angle of the seat surface and the rotating mechanism serving to control the rotation of the seat surface. Consequently, the proposed rotating vehicle seat takes up layout space and the wiring arrangement and control thereof is complex.

The present invention was conceived in view of these problems and its object is to provide a rotating vehicle seat that can achieve a greater degree of simplification.

In order to achieve the aforementioned object, a rotating vehicle seat according to a first aspect is a rotating seat for a vehicle having a seat surface tilt angle varying mechanism, a seat surface rotating mechanism and a single drive source. The seat surface tilt angle varying mechanism is configured and arranged to vary a tilt angle of a seat surface of a seat body. The seat surface rotating mechanism is configured and arranged to rotate the seat surface. The drive source is configured and arranged to drive the seat surface tilt angle varying mechanism and the seat surface rotating mechanism.

With this rotating vehicle seat, since the seat surface tilt angle varying mechanism and the seat surface rotating mechanism are both driven with a single drive source, the tilt angle of the seat surface can be varied and the seat surface can be rotated with one drive source.

Consequently, the number of component parts can be reduced and the structure can be simplified in comparison with a case in which a separate drive source is provided for each of the seat surface tilt angle varying mechanism and the seat surface rotating mechanism.

Additionally, the layout space can be reduced and the wiring arrangement and control can be simplified.

A rotating vehicle seat according to a second aspect, the seat surface tilt angle varying mechanism preferably includes a first link member configured and arranged to raise and lower a first end portion of the seat surface using a drive force from the drive source, and the seat surface rotating mechanism preferably includes a second link member configured and arranged to displace a second end portion of the seat surface in a horizontal direction in response to a displacement of the seat surface by the first link member.

More specifically, when the first link member is driven by a drive force from the drive source, the first end portion of the seat surface is raised or lowered and the tilt angle of the seat surface is thereby varied.

Meanwhile, the second link member operates in response to the displacement of the seat surface caused by the first link member and causes the second end portion of the seat surface to be displaced in a horizontal direction, thereby rotating the seat surface.

In a rotating vehicle seat according to a third aspect, a drive link member is preferably coupled between the first link member of the seat surface tilt angle varying mechanism and the drive source with a retraction position of the drive link member being set such that a force oriented in a return direction is applied to the first link member when the seat body is in a pre-rotation position.

More specifically, when the seat surface is in a state of having been returned to a pre-rotation position, a drive link member serving to actuate the first link is moved to a retraction position and a force oriented in a return direction is applied to the first link.

Consequently, the backlash that can occur in the mechanisms serving to drive the links is suppressed.

In a rotating vehicle seat according to a fourth aspect, an assist spring is preferably provided to apply a biasing force oriented in a raising direction against the first end portion of the seat surface.

More specifically, since a sitting passenger causes a downward load to act on the seat surface, a speed at which the first end portion is lowered tends to be faster than a speed at which the same is raised when the tilt angle of the seat surface is varied by raising and lowering the first end portion of the seat surface.

By applying a force in the raising direction against the first end portion of the seat surface, the assisting spring can help raise the first end portion of the seat surface.

A rotating vehicle seat according to a fifth aspect, a looseness preventing structure is preferably provided to prevent looseness of the seat body with respect to a base frame by fitting a first member coupled to the seat body with a second member provided in the base frame when the seat body is in a pre-rotation position.

More specifically, when the seat body is in a state of having been returned to a pre-rotation position, looseness of the seat body is prevented by a looseness preventing structure configured to prevent looseness of the seat body by means of a fitting together of the first and second members.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a disassembled view of a rotating vehicle seat in accordance with an illustrated embodiment of the present invention;

FIG. 2 includes top plan views illustrating an operation of the rotating vehicle seat in accordance with the illustrated embodiment;

FIG. 3 includes side elevational views illustrating an operation of the rotating vehicle seat in accordance with the illustrated embodiment;

FIG. 4 is a rear perspective view of a rotation unit of the rotating vehicle seat in accordance with the illustrated embodiment;

FIG. 5 is a frontal perspective view of the rotation unit of the rotating vehicle seat in accordance with the illustrated embodiment;

FIG. 6 is a frontal perspective view of the rotation unit of the rotating vehicle seat when the rotation unit is in a post-rotation position in accordance with the illustrated embodiment;

FIG. 7 is a rear perspective view of the rotation unit of the rotating vehicle seat showing a retraction limit switch and an extension limit switch provided on the rotation unit in accordance with the illustrated embodiment;

FIG. 8 is a side elevational view of the rotation unit showing an operation of the retraction limit switch and the extension limit switch in accordance with the illustrated embodiment;

FIG. 9 is a side elevational view of the rotation unit in accordance with the illustrated embodiment;

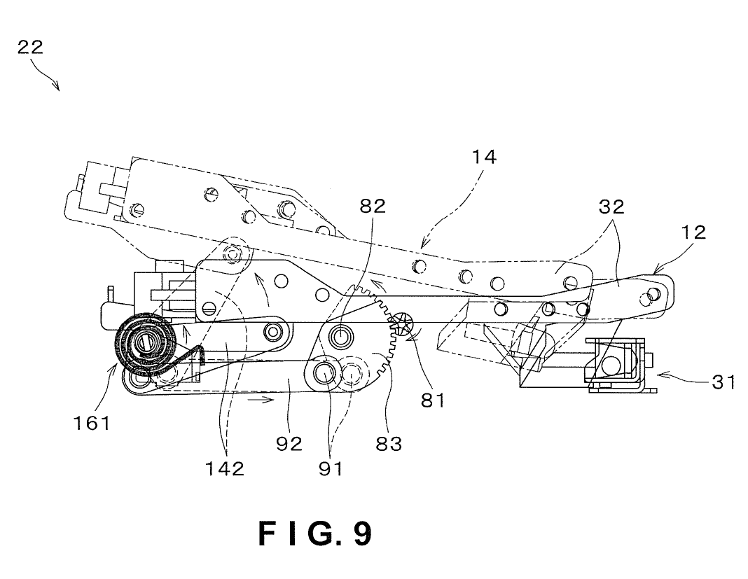

FIG. 10 includes a side elevational view of the rotation unit and an enlarged view perspective view of a looseness preventing mechanism in accordance with the illustrated embodiment; and

FIG. 11 includes diagrams illustrating an operation of a link mechanism of the rotating vehicle seat in accordance with the illustrated embodiment.

### DETAILED DESCRIPTION OF THE PREFERRED EMBODIMENT

A selected embodiment of the present invention will now be explained with reference to the drawings. It will be apparent to those skilled in the art from this disclosure that the following description of the embodiment of the present invention is provided for illustration only and not for the purpose of limiting the invention as defined by the appended claims and their equivalents.

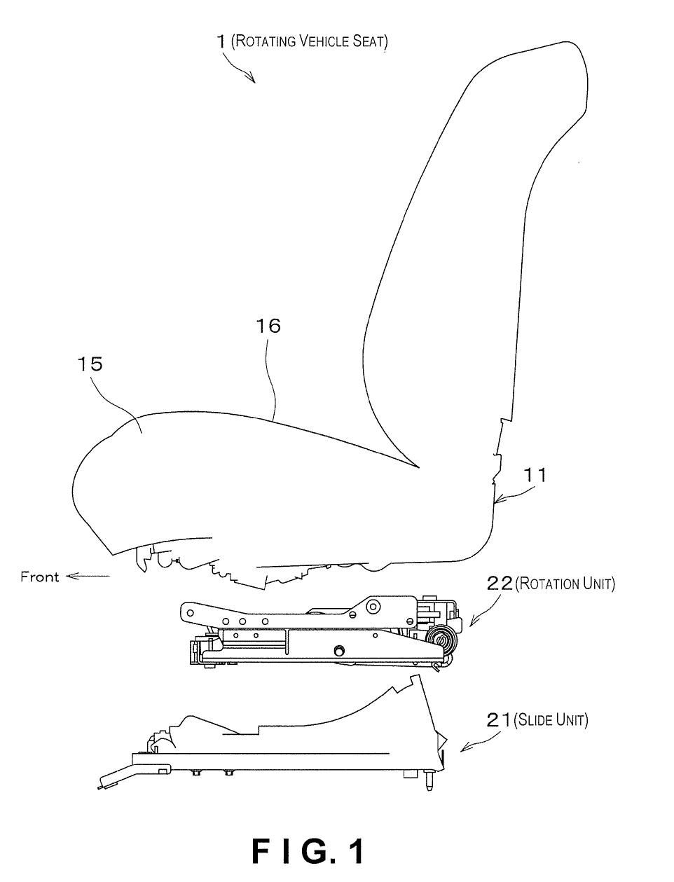

FIG. 1 is shows a rotating vehicle seat 1 in accordance with the embodiment.

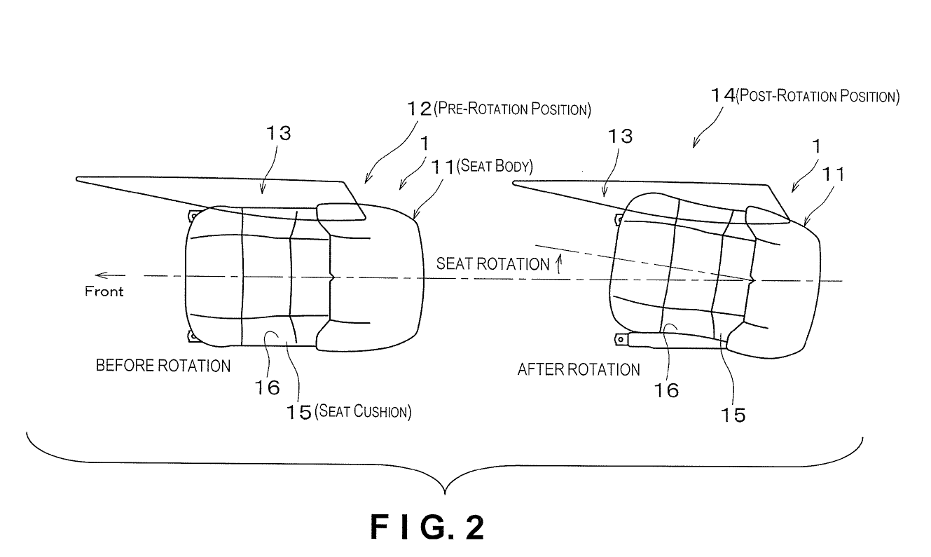

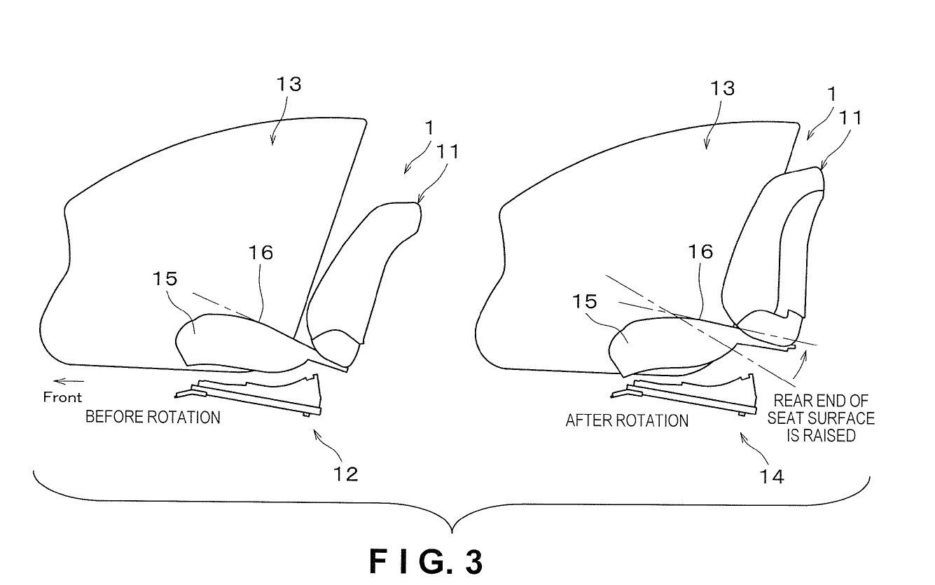

As shown in FIG. 2, the rotating vehicle seat 1 is installed as a driver's seat of a vehicle and includes a seat body 11 serving as a seat portion on which a driver sits. The rotating vehicle seat 1 is contrived such that the seat body 11 can be rotated between a pre-rotation position 12 in which the seat body 11 faces toward a front F of the vehicle and a post-rotation position 14 in which the seat body 11 faces toward an embarkation opening 13 provided in a right side portion of the vehicle. Additionally, as shown in FIG. 3, the rotating vehicle seat 1 is configured to raise a rearward end portion (first end portion) of a seat surface 16 of a seat cushion 15 of the seat body 11 when the seat body 11 is rotated from the pre-rotation position 12 to the post-rotation position 14. Since the seat surface 16 is arranged to slant upward toward the front of the vehicle in the pre-rotation position 12, raising the rearward end portion of the seat surface 16 in the post-rotation position 14 improves the ease with which a passenger can get out of the seat. Thus, the rotating vehicle seat 1 is provided with a seat surface tilt angle varying function whereby it can vary a tilt angle of the seat surface 16 of the seat body 11 and a seat surface rotating function whereby it can rotate the seat surface 16.

As shown in FIG. 1, the seat body 11 is supported on the vehicle body through a slide unit 21 that is mounted to a floor of the vehicle body such that it can slide along a longitudinal direction of the vehicle and a rotation unit 22 that is mounted to the slide unit 21.

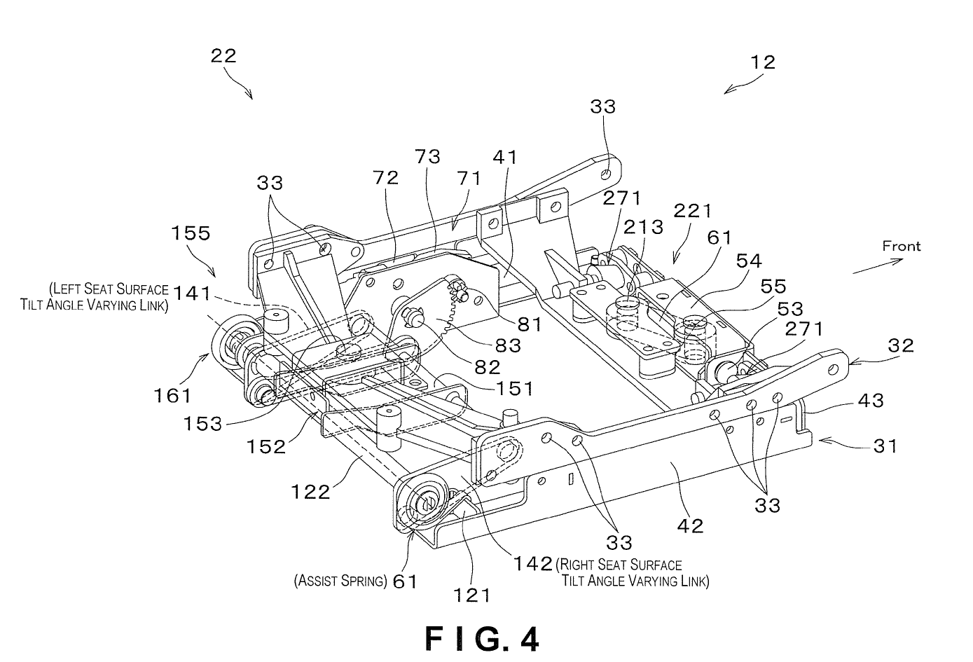

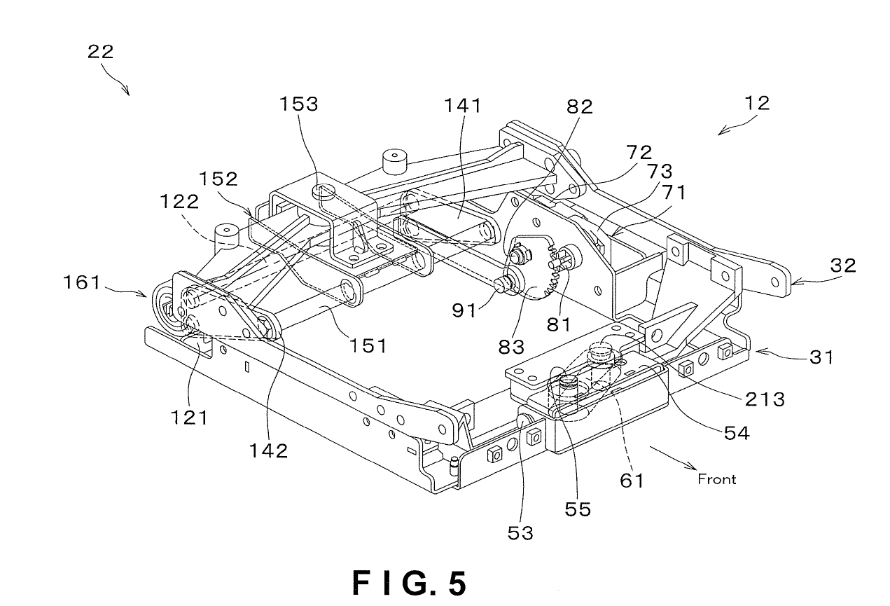

As shown in FIGS. 4 to 7, the rotation unit 22 includes a base 31 (base frame) that is fixed to the slide unit 21 and a movable section 32 that is movably supported on the base 31. A plurality of fastening points 33 are provided on the movable section 32 such that the seat cushion 15 can be fastened thereto.

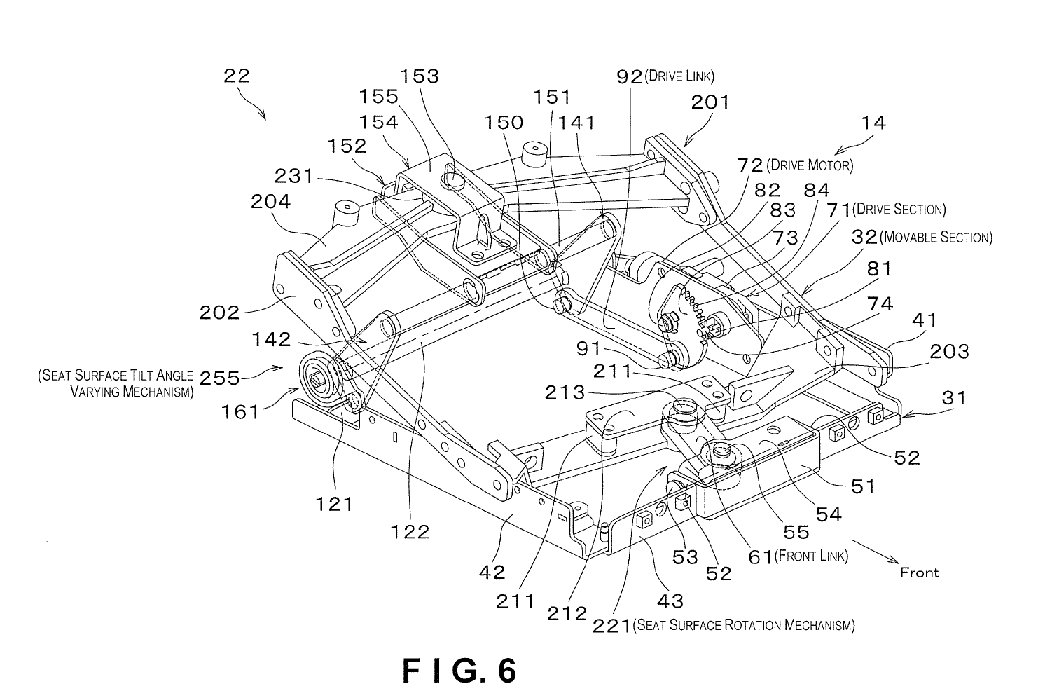

As shown in FIG. 6, the base 31 comprises a left side member 41 and a right side member 42 arranged opposite each other and a cross member 43 arranged so as to join the frontward end portions of the two side members 41 and 42. The base 31 is thus generally C-shaped and the open side thereof faces in a rearward direction.

A generally C-shaped front bracket 51 is provided in a middle portion of the cross member 43 and arranged such that the open side thereof faces in a rearward direction. A front link bracket 54 is pivotally supported on side panels 52 and 52 of the front bracket 51 with front shafts 53 and 53. A front rotary shaft 55 is provided in a rightward position of the front link bracket 54, and an upper end and a lower end of the front rotary shaft 55 are fixed to the front link bracket 54.

A frontward end portion of a front link 61 serving as a second link member is rotatably supported on the front rotary shaft 55 such that the front link 61 can swing about the front rotary shaft 55 between a state in which a free end thereof is close to the cross member 43 and a state in which the free end extends rearward.

A drive section 71 is provided at a middle portion of the left side member 41 of the base 31. The drive section 71 includes a drive motor 72 that serves as a drive source and is controlled with electric power supplied from a control apparatus not shown in the figures, and a reduction gear unit 73 that has a worm gear actuated by the drive motor 72. An output shaft 74 extends from the reduction gear unit 73 and passes through an inside surface of the left side member 41.

A pinion gear 81 is fixed to the output shaft 74, and the pinion gear 81 is configured and arranged to mesh with a rotary gear 83 that is rotatably supported on an inside surface of the left side member 41 with a rotary shaft 82. The rotary gear 83 is fan-shaped and has a gear portion 84 configured to mesh with the pinion gear 81 formed on an outer circumferential edge thereof.

A protruding drive shaft 91 for transmitting a drive force is provided on the circumferential edge of the rotary gear 83, and a frontward end portion of an elongated plate-like drive link 92 (drive link member) is rotatably supported on the drive shaft 91. Thus, by rotating the rotary gear 83 with the drive motor 72 such that the drive shaft 91 moves forward or rearward, the drive link 92 supported on the drive shaft 91 can be displaced in a forward or rearward (longitudinal) direction.

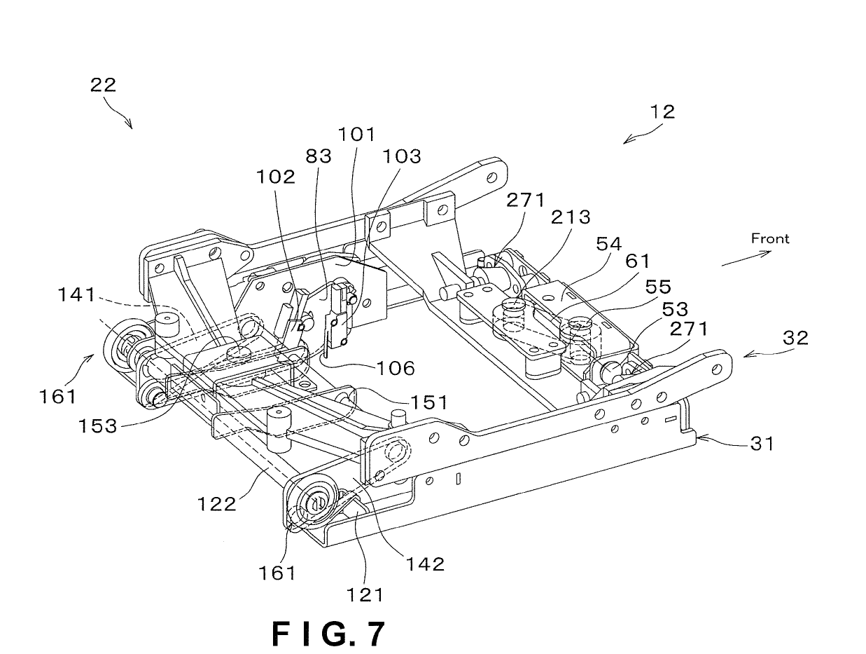

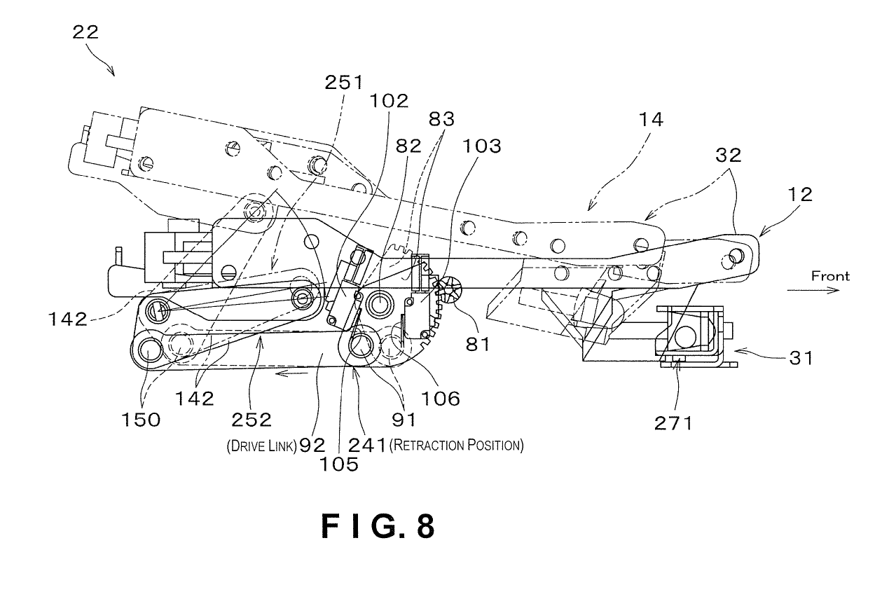

As shown in FIGS. 7 and 8, the rotary gear 83 is configured to be covered with a cover 101 (one side face of the cover 101 is shown in FIG. 7) and a retraction limit switch 102 and an extension limit switch 103 are provided on an inside surface of the cover 101.

The retraction limit switch 102 is arranged rearward of the extension limit switch 103 and configured to turn off when a retraction contact 105 extending from the retraction limit switch 102 touches against the drive shaft 91 of the rotary gear 83.

The extension limit switch 103 is arranged forward of the retraction limit switch 102 and configured to turn off when an extension contact 106 extending from the extension limit switch 103 touches against the drive shaft 91.

As shown in FIG. 4, a shaft support bracket 121, 121 is provided on a rearward end portion each of the side members 41 and 42 of the base 31. An end portion of a rear shaft 122 is rotatably supported on each of the shaft support brackets 121 and 121 and the rear shaft 122 is arranged to span between rearward end portions of the two side members 41 and 42 of the base 31.

A left seat surface tilt angle varying link 141 is provided on a left end portion of the rear shaft 122. The left seat surface tilt angle varying link 141 is an elongated triangular plate-like member that serves as a first link member. A right seat surface tilt angle varying link 142 is provided on a right end portion of the rear shaft 122. The right seat surface tilt angle varying link 142 is an elongated triangular plate-like member that serves as a first link member. As shown in FIG. 6, the right end portion of the rear shaft 122 is fixed in such a state that it passes through a rearward bottom corner portion of the left seat surface tilt angle varying link 141, and end portion of the rear shaft 122 is fixed in such a state that it passes through a rearward bottom corner portion of the right seat surface tilt angle varying link 142.

A rearward end portion of the drive link 92 is rotatably supported on a frontward bottom corner portion of the left seat surface tilt angle varying link 141 through with a shaft part 150. Thus a longitudinal (forward or rearward) displacement of the drive shaft 91 accompanying a rotation of the rotary gear 83 can be transmitted to the left seat surface tilt angle varying link 141 through the drive link 92.

The apex portions of the two seat surface tilt angle varying links 141 are connected with a connecting pipe 151, and a frontward end portion of a rear link bracket 152 is rotatably fitted on the outside of the connecting pipe 151. The rear link bracket 152 is configured to extend rearward from the connecting pipe 151, and an upwardly extending rear rotary shaft 153 is provided on the rear link bracket 152. An upper end portion of the rear rotary shaft 153 is rotatably supported in a roof panel 155 of a hat-shaped part 154 provided in the rear link bracket 152.

As shown in FIGS. 4 and 6, spiral-type assist springs 161 and 161 are provided at both end portions of the rear shaft 122. The end portion of each of the assist springs 161 that is at the center of the spiral is fixed to the rear shaft 122 and the other end, i.e., the outer end, is securely engaged with the corresponding shaft support bracket 121. Thus, the assist springs 161 and 161 apply spring forces against the rear shaft 122 in directions acting to stand the seat surface tilt angle varying links 141 and 142 upright.

As shown in FIG. 6, the movable section 32 has the form of a rectangular frame comprising a left side plate 201 and a right side plate 202 arranged opposite each other, a front connecting plate 203 connecting frontward end portions of the side plates 201 and 202, and a rear connecting plate 204 connecting rearward end portions of the side plates 201 and 202.

A clamping plate 212 is provided on a middle portion of the front connecting plate 203 with column-like support parts (spacers) 211 arranged in-between, and a coupling shaft 213 is provided between the clamping plate 212 and the front connecting plate 203 in a leftward position. The front link 61 extends from the base 31 and a rearward end portion thereof is rotatably supported on the coupling shaft 213. Thus, when the front link 61 rotates about the front rotary shaft 55, the frontward end portion of the movable section 32 is displaced in a horizontal direction.

As a result, a frontward end portion (second end portion) of the seat body 11 supported on the movable section 32 can be moved in a horizontal direction, and a seat surface rotating mechanism 221 that can rotate the seat surface 16 is achieved.

The rear connecting plate 204 of the movable section 32 is generally V-shaped and arranged such that a middle portion thereof protrudes rearward. A boss 231 having a vertically oriented through-hole formed therein is integrally formed at the middle portion of the rear connecting plate 204. The rear rotary shaft 153 provided on the rear link bracket 152 passes through the boss 231 such that it can rotate freely therein.

The rear connecting plate 204 of the movable section 32 is supported on the base 31 through the rear link bracket 152 and the seat surface tilt angle varying links 141 and 142 on which the rear link bracket 152 is supported, and rotation of the seat surface tilt angle varying links 141 and 142 causes the rear connecting plate 204 to move up and down. The seat cushion 15 is supported on the movable section 32 through the seat surface tilt angle varying links 141 and 142. As a result, a seat surface tilt angle varying mechanism 255 is achieved which can vary a tilt angle of the seat surface 16 of the seat cushion 15.

Since the seat surface tilt angle varying links 141 and 142 are supported on the rear shaft 122 and the assist springs 161 and 161 apply spring forces against the rear shaft 122 in directions acting to stand the seat surface tilt angle varying links 141 and 142 upright, a force oriented in a raising direction can be applied against the rearward end portion of the seat surface 16 of the seat cushion 15 supported on the movable section 32.

Thus, the spring forces from the assist springs 161 and 161 can serve to counteract the weight load of a seated passenger.

When the seat surface tilt angle varying links 141 and 142 are rotated by the drive section 71, the longitudinal (rearward or forward) displacements of the free ends of the seat surface tilt angle varying links 141 and 142 cause the rear link bracket 152 supported on the seat surface tilt angle varying links 141 and 142 and the movable section 32 supported on the rear link bracket 152 to move in a longitudinal direction (rearward or forward). The longitudinal movement of the movable section 32 causes the front link 61 supported on the front rotary shaft 55 of the base 31 to swing such that the frontward end portion of the movable section 32 (which is supported on the free end portion of the front link 61) is displaced in a leftward or rightward direction.

Since the seat cushion 15 is supported on the movable section 32 by the seat surface tilt angle varying links 141 and 142, the displacement of the movable section 32 causes the seat surface 16 of the seat cushion 15 to be displaced such that a frontward end portion of the seat surface 16 is displaced in a horizontal direction.

In this way, the seat surface tilt angle varying mechanism 225 (including the seat surface tilt angle varying links 141 and 142, which serve to vary a tilt angle of the seat surface 16) and the seat surface rotating mechanism 221 (including the front link 61, which serves to rotate the seat surface 16) can be driven with a single drive motor 72 because when the drive motor 72 rotates the seat surface tilt angle varying links 141 and 142, the front link 61 rotates in coordination with the movement of the seat surface tilt angle varying links 141 and 142.

As shown in FIGS. 7 and 8, the retraction limit switch 102 and the extension limit switch 103 are provided on the cover 101 that covers the rotary gear 83 and are configured to turn off when contacted by the drive shaft 91 of the rotary gear 83. The extension limit switch 103 is provided in such a position that the drive shaft 91 touches against the extension contact 106 of the extension limit switch 103 when the drive motor 72 rotates the rotary gear 83 such that the seat body 11 reaches the post-rotation position 14.

The extension limit switch 103 is connected to the aforementioned control apparatus and the control apparatus is configured to cut off electric power to the drive motor 72 and stop driving the drive link 92 in a feed direction when it receives a signal indicating that the extension limit switch 103 has turned off. As a result, the rotation and tilting of the seat body 1I can be stopped when the seat body 11 reaches the post-rotation position 14.

The retraction limit switch 102 is provided in such a position that the drive shaft 91 touches against the retraction contact 105 of the retraction limit switch 102 when the drive motor 72 rotates the rotary gear 83 such that the seat body 11 reaches the pre-rotation position 12.

The retraction limit switch 102, too, is connected to the control apparatus and the control apparatus is configured to cut off electric power to the drive motor 72 and stop driving the drive link 92 in a return direction when it receives a signal indicating that the retraction limit switch 102 has turned off. As a result, the rotation and tilting of the seat body 11 can be stopped when the seat body 11 reaches the pre-rotation position 12.

The retraction limit switch 102 is fixed in a slightly forward position such that a force is applied in a return direction against the left seat surface varying link 141 when the set surface 16 has been returned to the pre-rotation position 12. The retraction position 241 of the drive link 92 (which drives the seat surface tilt angle varying links 141 and 142) is determined by the position in which the retraction limit switch 102 is fixed.

Electric power continues to be supplied to the drive motor 72 when the seat body 11 reaches the per-rotation position 12 and the electric power is cut off when the rotary gear 83 has been rotated further. The seat surface tilt angle varying links 141 and 142 are stopped at a tension application position 252 reached when the seat surface tilt angle varying links 141 and 142 have rotated slightly beyond a return complete position 251 in the return direction. The return complete position 251 is a position the seat surface tilt angle varying links 141 and 142 reach when the seat body 11 is returned to the pre-rotation position 12. The seat body 11 is held in the pre-rotation position 12 by being mechanically locked.

The rotary gear 83 is connected to a reduction gear unit 73 that includes a worm gear having a reverse rotation preventing function. Consequently, while the drive motor is stopped, a tension can be applied continuously in a return direction against the seat surface tilt angle varying links 141 and 142.

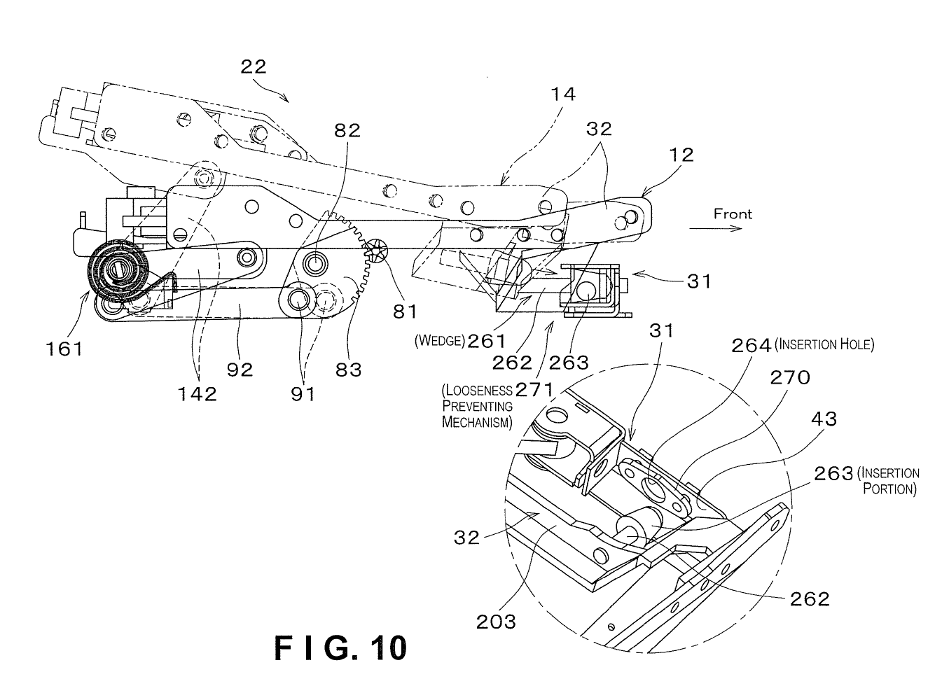

As shown in FIG. 10, a wedge 261 (first member) is provided on a lower portion of the front connecting plate 203 of the movable section 32. The wedge 261 comprises a neck portion 262 and a tapered insertion portion 263 provided on the neck portion 262 such that the wedge 261 has a mushroom-like shape.

An elliptical positioning plate 270 (second member) is provided on the cross member 43 of the base 31 in a position corresponding to the wedge 261. A circular insertion hole 264 configured for the insertion portion 263 of the wedge 261 to fit into is provided in the positioning plate 270.

The positioning plate 270 is fixed in such a position that the insertion portion 263 of the wedge 261 fits into the insertion hole 264 when the seat body 11 is in the pre-rotation position 12 and the seat surface 16 is facing toward the front of the vehicle. The fitting together of the wedge 261 and the insertion hole 264 constitutes a looseness preventing structure 271 that serves to prevent looseness of the seat surface 16.

Since a rotating vehicle seat 1 according to this embodiment is contrived such that the seat surface tilt angle varying mechanism 255 and the seat surface rotating mechanism 221 can be driven with a single drive motor 72, both variation of the tilt angle and rotation of the seat surface 16 of the seat cushion 15 can be accomplished with one drive motor 72.

Consequently, the number of component parts can be reduced and the structure can be simplified in comparison with a case in which the seat surface tilt angle varying mechanism 255 and the seat surface rotating mechanism 221 are driven by separate drive motors. Additionally, the wiring arrangement and control can be simplified. As a result, the cost can be reduced.

Also, since the layout space can be reduced, the degree of layout freedom can be increased.

Driving the seat surface tilt angle varying mechanism 255 and the seat surface rotating mechanism 221 with a single drive motor 72, i.e., a dual action with one motor, can feasibly be accomplished using a wire configuration or a link configuration. This embodiment uses a link configuration. Thus, the tilt angle of the seat surface 16 can be varied by using a drive force from the drive motor 72 to drive the seat surface tilt angle links 141 and 142 so as to raise and lower the rearward end portion of the seat surface 16.

In response to the displacement of the seat surface 16 caused by the seat surface tilt angle varying links 141 and 142, the front link 61 operates and displaces the frontward end portion of the seat surface 16 in a horizontal direction, thereby rotating the seat surface 16. As a result, both tilting and rotation of the seat surface 16 can be accomplished with a single drive motor 72.

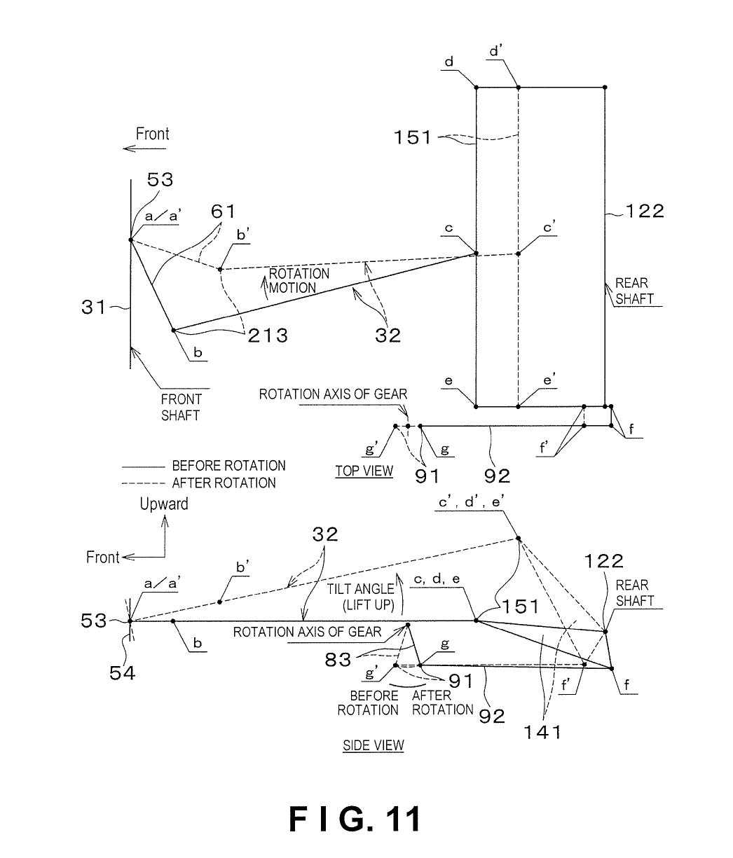

FIG. 11 is a schematic view of a link mechanism in which parts corresponding to the preceding drawings are indicated with corresponding reference numerals.

This figure, too, illustrates that the rotary operation of the rotary gear 83 rotated by the drive motor 72 serves to raise/lower and rotate a rearward end portion of the movable section 32 in a coordinated manner such that the seat surface 16 of the seat body 11 supported on the movable section 32 can be tilted and rotated.

When a passenger sits on the seat surface 16 of the seat body 11, the weight of the passenger generates a downward load and the rearward end portion of the seat surface 16 tends to move downward faster than it moves upward when it is raised and lowered to vary the tilt angle.

In this embodiment, the assist springs 161 and 161 provided on the rear shaft 122 apply a spring force against the seat surface tilt angle varying links 141 and 142 in a direction of raising the rearward end portion of the seat surface 16 of the seat body 11, thereby providing assistance when the rearward end portion of the seat surface 16 is raised.

As a result, an increase in the lowering speed of the rearward end portion of the seat surface 16 caused by the weight of a passenger can be suppressed and the difference between the raising speed and lowering speed can be decreased.

Additionally, since the drive force required in order to raise the rearward end portion can be reduced, a motor having a smaller output can be used, i.e., the drive motor 72 can be made more compact.

The retraction position 241 of the drive link 92 that drives the seat surface tilt angle varying links 141 and 142 is set according to the position in which the retraction limit switch 102 is fixed such that when the seat surface has been returned to the pre-rotation position 12, a force acting in the return direction is applied against each of the seat surface tilt angle varying links 141 and 142.

As a result, when the seat surface 16 of the seat body 11 is returned to the pre-rotation position 12, the drive link 92 that drives seat surface tilt angle varying links 141 and 142 is moved to the retraction position 241 and the force acting in the return direction can be applied against the seat surface tilt angle varying links 141 and 142 in a continuous fashion.

As a result, the backlash that can occur in the links 92, 141, and 142, the rotary gear 83, the pinion gear 81, and other mechanisms can be suppressed and undesired looseness of the seat surface 16 of the seat body 11 driven by the seat surface tilt angle varying links 141 and 142 can be prevented.

When the seat body 11 is in the pre-rotation position 12, the insertion portion 263 of the wedge 261 provided on the movable section 32 fits into the insertion hole 264 of the positioning plate 270 provided on the base 31, thus constituting a looseness preventing structure 271 that can prevent undesired looseness of the seat surface 16 of the seat body 11 from occurring.

Although in this embodiment the looseness preventing structure 271 is accomplished using the wedge 261, the invention is not limited to such a structure. For example, a dovetail could be used.

With a rotating vehicle seat according to the illustrated embodiment, since the seat surface tilt angle varying mechanism and the seat surface rotating mechanism can be driven with a single drive source, both variation of the tilt angle of the seat surface and rotation of the seat surface can accomplished with one drive source.

Consequently, the number of component parts can be reduced in comparison with a case in which a separate drive source is provided for each of the seat surface tilt angle varying mechanism and the seat surface rotating mechanism and the structure can be simplified. Furthermore, the wiring arrangement and the control can be simplified. As a result, the cost of the rotating vehicle seat can be reduced.

Also, since the amount of layout space required can be reduced, a higher degree of freedom can be obtained with respect to the layout of the rotating vehicle seat.

With a rotating vehicle seat according to the illustrated embodiment, the tilt angle of the seat surface can be varied by driving the first link member with a drive force from the drive source so as to raise and lower the first end portion of the seat surface.

When this is done, the second link member displaces the second end portion of the seat surface in a horizontal direction in response to a displacement of the seat surface by the first link member, thereby enabling the seat surface to be rotated.

As a result, both tilting and rotation of the seat surface can be accomplished with a single drive source.

With a rotating vehicle seat according to the illustrated embodiment, when the seat surface returns to a pre-rotation position, a drive link member serving to actuate the first link member moves to a retraction position and thereby applies a force oriented in a return direction against the first link member.

As a result, the backlash that can occur in the mechanisms serving to drive the links can be suppressed and undesired looseness of the seat surface driven by the links can be prevented.

With a rotating vehicle seat according to the illustrated embodiment, assistance can be accomplished with respect to raising the first end portion of the seat surface by means of the assisting spring applying a force oriented in a raising direction against the first end portion of the seat surface.

As a result, when the first end portion of the seat surface is lowered while bearing a load from a seated passenger, an increase in the lowering speed can be suppressed. Thus, the difference between the raising speed and the lowering speed of the first end portion can be reduced.

A rotating vehicle seat according to the illustrated embodiment is provided with a looseness preventing structure configured to prevent looseness of the seat surface by means of a fitting together of members when the seat surface has been returned to a pre-rotation position. As a result, undesired looseness of the seat surface can be prevented.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment, the following directional terms “forward”, “rearward”, “above”, “downward”, “vertical”, “horizontal”, “below” and “transverse” as well as any other similar directional terms refer to those directions of a vehicle equipped with the present invention. Accordingly, these terms, as utilized to describe the present invention should be interpreted relative to a vehicle equipped with the present invention. The terms of degree such as “substantially”, “about” and “approximately” as used herein mean a reasonable amount of deviation of the modified term such that the end result is not significantly changed.

While only selected embodiment has been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing description of the embodiment according to the present invention is provided for illustration only, and not for the purpose of limiting the invention as defined by the appended claims and their equivalents.

What is claimed is:

1. A rotating seat for a vehicle comprising:
a seat surface tilt angle varying mechanism configured and arranged to vary a tilt angle of a seat surface of a seat body;
a seat surface rotating mechanism configured and arranged to rotate the seat surface; and
a single drive source configured and arranged to drive the seat surface tilt angle varying mechanism and the seat surface rotating mechanism.

2. The rotating vehicle seat recited in claim 1, wherein
the seat surface tilt angle varying mechanism includes a first link member configured and arranged to raise and lower a first end portion of the seat surface using a drive force from the drive source, and
the seat surface rotating mechanism includes a second link member configured and arranged to displace a second end portion of the seat surface in a horizontal direction in response to a displacement of the seat surface by the first link member.

3. The rotating vehicle seat recited in claim 2, further comprising
a drive link member coupled between the first link member of the seat surface tilt angle varying mechanism and the drive source with a retraction position of the drive link member being set such that a force oriented in a return direction is applied to the first link member when the seat body is in a pre-rotation position.

4. The rotating vehicle seat recited in claim 2, further comprising
an assist spring configured and arranged to apply a biasing force oriented in a raising direction against the first end portion of the seat surface.

5. The rotating vehicle seat recited in claim 3, further comprising
an assist spring configured and arranged to apply a biasing force oriented in a raising direction against the first end portion of the seat surface.

6. The rotating vehicle seat recited in claim 1, further comprising
a looseness preventing structure configured and arranged to prevent looseness of the seat body with respect to a base frame by fitting a first member coupled to the seat body with a second member provided in the base frame when the seat body is in a pre-rotation position.

7. The rotating vehicle seat recited in claim 2, further comprising
a looseness preventing structure configured and arranged to prevent looseness of the seat body with respect to a base frame by fitting a first member coupled to the seat body with a second member provided in the base frame when the seat body is in a pre-rotation position.

8. The rotating vehicle seat recited in claim 3, further comprising
a looseness preventing structure configured and arranged to prevent looseness of the seat body with respect to a base frame by fitting a first member coupled to the seat body with a second member provided in the base frame when the seat body is in the pre-rotation position.

9. The rotating vehicle seat recited in claim 4, further comprising
a looseness preventing structure configured and arranged to prevent looseness of the seat body with respect to a base frame by fitting a first member coupled to the seat body with a second member provided in the base frame when the seat body is in a pre-rotation position.
